(19) United States
(12) Patent Application Publication
(10) Pub. No.: US 2022/0092116 A1
(43) Pub. Date: Mar. 24, 2022

(54) AUTOMATIC GRAPH DATABASE QUERY CONSTRUCTION AND EXECUTION

(71) Applicant: Citrix Systems, Inc., Ft. Lauderdale, FL (US)

(72) Inventors: R V Shouri Gupta, Bangalore (IN); Subramanian Ramamurti, Bangalore (IN); Isha Sinha, New Delhi (IN); Hemant S. Huse, Shegaon (IN)

(73) Assignee: Citrix Systems, Inc., Ft. Lauderdale, FL (US)

(21) Appl. No.: 17/029,400

(22) Filed: Sep. 23, 2020

(51) Int. Cl. G06F 16/901; G06F 16/248; G06F 16/2455

(52) U.S. Cl. CPC G06F 16/9024; G06F 16/24553; G06F 16/248

(57) ABSTRACT

A method for translating a generic database query to a graph database query includes receiving a first database query including one or more selection sets each defining at least one database field to be queried from a graph database, where the first database query is coded in a generic query language and the at least one database field is represented in the graph database as a property of a vertex. For each of the selection sets, a second database query including a select clause representing a request to retrieve the property of the vertex from the graph database is generated, where the second database query is coded in a graph query language. The second database query is encapsulated into a third database query configured to be executed on the graph database, the third database query including the second database query, a query type, and a graph name.

### BACKGROUND

In certain computing environments, analytical tools can be employed to provide users and administrators with insightful information for making decisions and improvements relating to the operation of those environments. For example, the analytical tools can be configured to determine the risk posed to data security by continuously or periodically evaluating the activities of a given entity in the environment. These tools gather data from various products or data sources to build dashboards, reports, and for other analytical purposes. The data represents, for example, information about various users, devices, and networks along with their relationships. Structured Query Language (SQL) relational databases have been used to store this data which, in turn, is accessed through various endpoints when the data is queried. SQL is a standardized query language for constructing queries to access and manipulate relational databases. However, SQL is not compatible with other types of databases, such as graph databases, due to their structural differences. Therefore, a different query language must be used with such databases. The format of the query depends on the type of database, since different types of databases can utilize different query formats. Thus, building such queries can be incommodious to users who are unfamiliar with the specific database query requirements.

### SUMMARY

One example provides a graph database query construction and execution method including receiving a first database query including one or more selection sets each defining at least one database field to be queried from a graph database, where the first database query is coded in a generic query language, where the at least one database field is represented in the graph database as a property of a vertex; generating, for each of the one or more selection sets, a second database query including a select clause representing a request to retrieve the property of the vertex from the graph database, where the second database query is coded in a graph query language; and encapsulating the second database query into a third database query configured to be executed on the graph database, the third database query including the second database query, a graph query type, and a graph name associated with the graph database. In some examples, the first database query includes a query condition, and the method includes inserting the query condition into the select clause. In some examples, the query condition includes one or more of: a where clause, an order by clause, and/or a limit clause. In some examples, the method includes determining whether the vertex includes a relation annotation, where the relation annotation is represented in the graph database by a relation on the vertex and/or by a relation on an edge connected to the vertex; and inserting, in response to determining that the vertex includes the relation annotation, a pattern constraint to the select clause, the pattern constraint corresponding into the relation annotation. In some examples, the method includes causing the third database query to be executed on the graph database to produce a response to the third database query; and causing the response to be rendered to a user via a user interface of a client computing device. In some examples, the response is coded in the graph query language, and the method includes recoding the response in the generic query language for rendering via the user interface. In some examples, the first database query is a GraphQL query, and the response is a GraphQL response. In some examples, the generic query language is different from the graph query language.

Another example provides a computer program product including one or more non-transitory machine-readable mediums having instructions encoded thereon that when executed by at least one processor cause a process to be carried out, the process including: receiving a first database query including one or more selection sets each defining at least one database field to be queried from a graph database, where the first database query is coded in a generic query language, where the at least one database field is represented in the graph database as a property of a vertex; generating, for each of the one or more selection sets, a second database query including a select clause representing a request to retrieve the property of the vertex from the graph database, where the second database query is coded in a graph query language; and encapsulating the second database query into a third database query configured to be executed on the graph database, the third database query including the second database query, a graph query type, and a graph name associated with the graph database. In some examples, the first database query includes a query condition, and the process includes inserting the query condition into the select clause. In some examples, the query condition includes one or more of: a where clause, an order by clause, and/or a limit clause. In some examples, the process includes determining whether the vertex includes a relation annotation, where the relation annotation is represented in the graph database by a relation on the vertex and/or by a relation on an edge connected to the vertex; and inserting, in response to determining that the vertex includes the relation annotation, a pattern constraint to the select clause, the pattern constraint corresponding into the relation annotation. In some examples, the process includes causing the third database query to be executed on the graph database to produce a response to the third database query; and causing the response to be rendered to a user via a user interface of a client computing device. In some examples, the response is coded in the graph query language, and the process includes recoding the response in the generic query language for rendering via the user interface. In some examples, the first database query is a GraphQL query, and the response is a GraphQL response.

Another example provides a system including a storage; and at least one processor operatively coupled to the storage, the at least one processor configured to execute instructions stored in the storage that when executed cause the at least one processor to carry out a process including receiving a first database query including one or more selection sets each defining at least one database field to be queried from a graph database, where the first database query is coded in a generic query language; generating, for each of the one or more selection sets, a second database query, where the second database query is coded in a graph query language; and encapsulating the second database query into a third database query configured to be executed on the graph database. In some examples, the first database query includes a query condition, and the process includes inserting the query condition into the second database query, where the query condition includes one or more of: a where clause, an order by clause, and/or a limit clause. In some examples, the process includes determining whether the graph database includes a relation annotation; and inserting, in response to determining that the graph database includes the relation annotation, a pattern constraint to the second database query, the pattern constraint corresponding into the relation annotation. In some examples, the process includes causing the third database query to be executed on the graph database to produce a response to the third database query; and causing the response to be rendered to a user via a user interface of a client computing device. In some examples, the response is coded in the graph query language, and the process includes recoding the response in the generic query language for rendering via the user interface.

Other aspects, examples, and advantages of these aspects and examples, are discussed in detail below. It will be understood that the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a data query/response process, in accordance with an example of the present disclosure.

FIG. 2 is a block diagram of another data query/response process, in accordance with an example of the present disclosure.

FIG. 3 is a block diagram of yet another data query/response process, in accordance with an example of the present disclosure.

FIG. 4A is a diagram of a graph database schema, in accordance with an example of the present disclosure.

FIGS. 4B-F show a GraphQL schema corresponding to the graph database schema of FIG. 4A, in accordance with examples of the present disclosure.

FIGS. 5A-C are flow diagrams of a method for automatically constructing a graph database query, in accordance with examples of the present disclosure.

FIGS. 6A-B show an example of a graph database query and response using the techniques disclosed herein.

FIGS. 7A-B show another example of a graph database query and response using the techniques disclosed herein.

FIG. 8 is a block diagram of a computing platform 800 configured to perform policy-based analytics, in accordance with an example of the present disclosure.

### DETAILED DESCRIPTION

As summarized above, at least some examples described in this disclosure are directed to techniques for translating a generic database query, such as a GraphQL query, to a graph database query, such as Cypher for a Neo4j graph database or GSQL for a Tiger Graph database. Such techniques are useful in conjunction with services that provide, for example, analytical insights of data received from one or more products. Such services collect data associated with entities in the user's environment, such as users, devices, and network information along with the relationships between these entities. The data generated from various onboarded products is stored in a graph database or datastore. The graph database can be queried to retrieve data for building reports, dashboards, and the like. This is achieved by translating a generic database query to a graph language query.

In accordance with an example of the present disclosure, a customer adds one or more products, such as a virtual application or desktop, a collaboration application or desktop, or other application to an analytical service. Data from these products flow into the analytical service. The data can represent, for example, device logins, network access, application execution, file creation and sharing, and other activities. The data are ingested into a graph database. Subsequently, users can query the graph database via the analytical service to retrieve data of interest. However, the format of the query depends on the type of database, since different types of databases can utilize different query formats. Furthermore, every query requirement corresponds to a separate query, and each query requires a new data endpoint for processing. Thus, as noted above, building such queries can be incommodious to users who are unfamiliar with the specific query requirements because they must be constructed according to, and with knowledge of, the structure of the database being queried. This poses challenges when the database structure is complex or unknown to the user.

To this end, examples of the present disclosure provide techniques for automatically generating a query for a graph database using a generic query language, such as GraphQL, which does not require the user to know the structure of the graph database. A schema representing a structure of the graph database is used to automatically translate the generic query to a graph query that comports with the structure of the graph database. A query language is a specification that defines the syntax and procedure for retrieving information from a database. Different query languages exist for different types of databases. For example, GraphQL is a language-independent (or generic) data query language developed as an alternate to Representational State Transfer (REST) and ad-hoc webservice architectures. GraphQL can be used as a substitute for a REST Application Programmable Interface (API) to access a graph database. REST APIs can become difficult to maintain especially when there are many endpoints. Also, REST APIs are dependent on the structure of the database, and thus require the developer of the API to have an intimate knowledge of that structure and how the endpoints correspond to the structure. In contrast to a REST API, GraphQL, or another suitable generic query language, can be used with any language and any database system because it is language-independent. Furthermore, in contrast to a REST API, GraphQL exposes only one endpoint.

Example Data Query/Response Processes

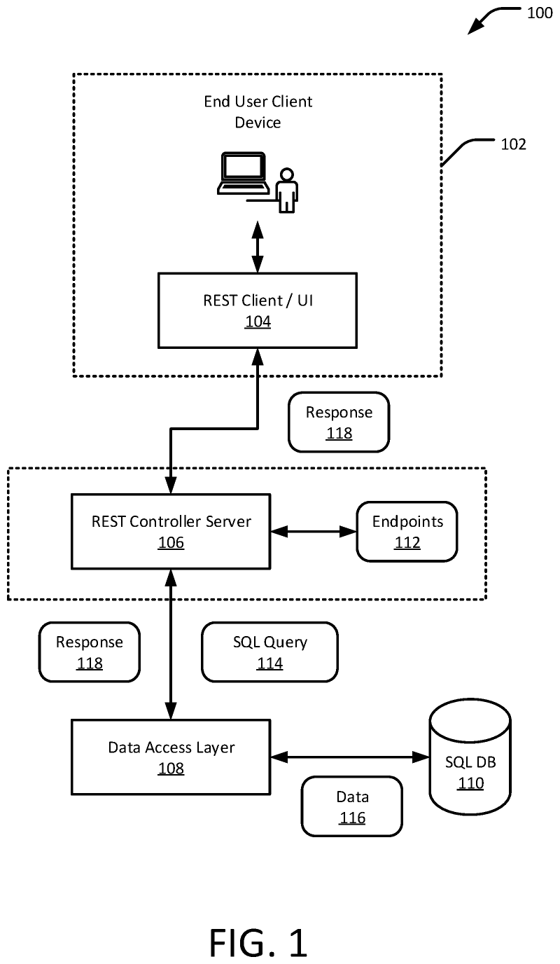

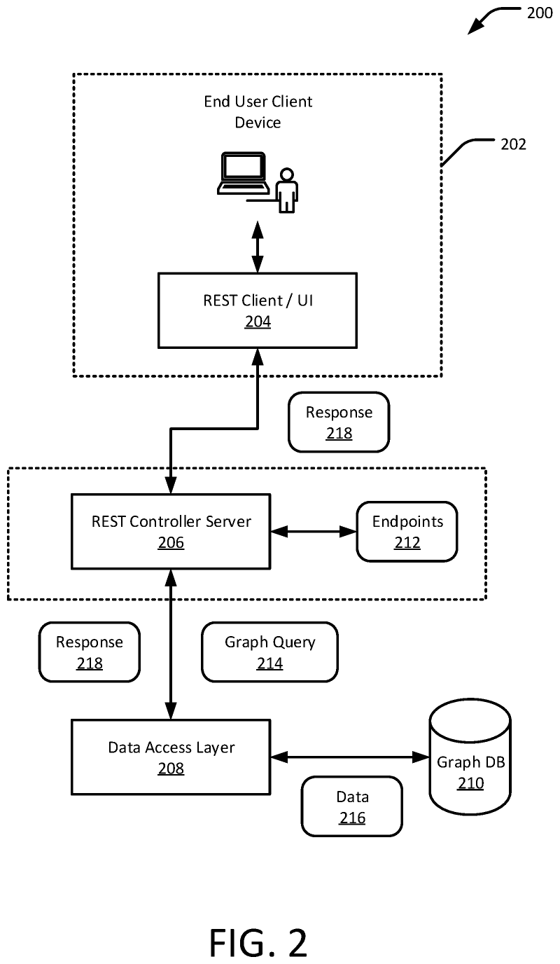

FIG. 1 is a block diagram of a data query/response process 100, in accordance with an example of the present disclosure. An end user client device 102 executes a REST client/user interface (UI) 104, which interacts with multiple REST-based endpoints 112 associated with a SQL database 110. The REST client/UI 104 exposes the endpoints 112 to the end user client device 102. The endpoints 112 are used to get, post, update, and/or delete data 116 from, to, or in the SQL database 110. For example, the endpoints 112 can be used to retrieve data to build reports and dashboards via a calling process. Each request by the REST client/UI 104 from the calling process corresponds to an individual SQL query 114 written by a developer. The SQL query 114 is processed by a REST controller server 106 via the data access layer 108, to obtain the data 116. Each SQL query 114 results in a unique endpoint 112 (i.e., each request corresponds to a unique endpoint). In operation, the REST client/UI 104 invokes one of the endpoints 112 via the server 106 and the SQL queries 114 are executed on the SQL database 110 via a data access layer 108, resulting in a response 118 to the REST client/UI 104 via the calling process. The REST client/UI 104 is suitable for use with SQL databases and, as described with respect to FIG. 2, graph databases.

FIG. 2 is a block diagram of another data query/response process 200, in accordance with an example of the present disclosure. In this example, data 216 is stored in a graph database 210 instead of in a conventional SQL database, as in FIG. 1. The graph database 210 is any database or datastore that uses graph structures for semantic queries with nodes (vertices), edges, and properties to represent and store data. The graph structure relates the data items in the store to various nodes and edges, the edges representing the relationships between the nodes. These relationships allow data in the store to be linked together directly and efficiently retrieved. Queries to graph databases are very fast compared to, for example, conventional relational databases (RDB, SQL, etc.) because the relationships are persistently stored. As described in further detail below, the structure of a graph database can be represented by a schema. The schema includes vertexes (or nodes), which are data entities, and edges, which are relationships between the data entities. When the data stored in the graph database is modified, the vertexes, the edges, and/or the properties of the vertexes and edges are changed. An example of a graph database that can be implemented with the disclosed techniques includes but is not limited to TigerGraph available from TigerGraph of Redwood City, Calif.

An end user client device 202 executes a REST client/user interface (UI) 204, which interacts with multiple REST-based endpoints 212 associated with the graph database 210. The REST client/UI 204 exposes the endpoints 212 to the end user client device 202. The endpoints 212 are used to get, post, update, and/or delete data 216 from, to, or in the graph database 210. For example, the endpoints 212 can be used to retrieve data to build reports and dashboards via a calling process. Each request by the REST client/UI 204 from the calling process corresponds to an individual graph query 214 written by a developer. The graph query 214 is processed by a REST controller server 206 via the data access layer 208, to obtain a response 218 from the graph database 210. As with the SQL query 114, the graph query 214 results in a unique endpoint 212 (i.e., each request corresponds to a unique endpoint). In operation, the REST client/UI 204 invokes one of the endpoints 212 via the server 206 and the graph queries 214 are executed on the graph database 210 via a data access layer 208, resulting in a response 218 to the REST client/UI 204 via the calling process.

The process 200 is similar to the process 100 of FIG. 1, except that because the database 210 has a graph structure instead of a SQL structure, the graph query 214 must be constructed in a graph query language (e.g., GSQL). The graph query language allows the client 202 to define the structure of the data 216, and the same structure of the data 216 is returned from the server 206 via the REST endpoints 212, therefore preventing excessively large amounts of data from being returned to the client 202. However, the graph query 214 must be constructed according to, and with knowledge of, the structure of the graph database 210. This poses challenges when the graph database structure is complex or unknown to the end user.

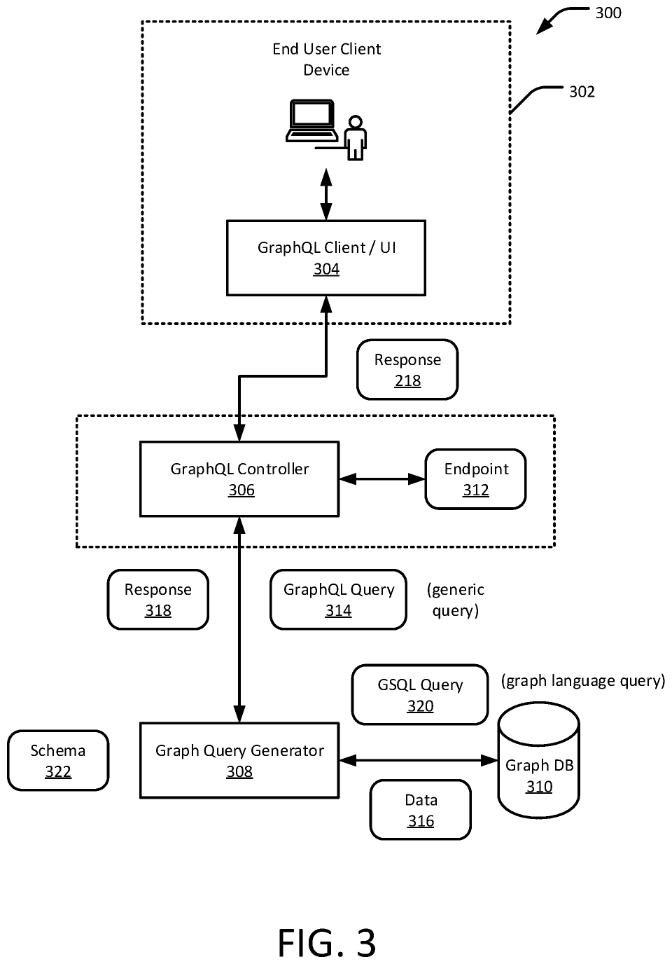

FIG. 3 is a block diagram of yet another data query/response process 300, in accordance with an example of the present disclosure. In contrast to the processes 100 and 200 of FIGS. 1 and 2, process 300 translates a generic query constructed in a generic database query language (e.g., GraphQL) to a graph query constructed in a graph query language (e.g., GSQL) query according to a schema associated with a graph database 310. The format of the query (e.g., GraphQL) is generic and adheres to the database schema. In this manner, the query does not need to be constructed with knowledge of the graph database structure. Rather, the schema of the graph database supports a translation of the query to its analogous graph query. For example, a GraphQL query is translated to a GSQL query, which is then executed on the graph database. It will be understood that this process is useful for translating the generic query into any graph query language and is not limited to the GraphQL query language or the GSQL graph query language.

An end user client device 302 executes a generic query language (e.g., GraphQL) client/user interface (UI) 304, which interacts with one or more resolvers exposed by the GraphQL controller 306 through a single endpoint 312 to obtain data from the graph database 310. The resolvers define one or more functions for generating a response to a graph query and includes at least one database field to be queried. The generic query language client/UI 304 exposes of the resolver(s), through the endpoint 312, to the end user client device 302. The endpoint 312 is used to get, post, update, and/or delete data 316 from, to, or in the graph database 310. For example, the endpoint 312 can be used to retrieve data to build reports and dashboards via a calling process. Each request by the generic query language client/UI 304 from the calling process corresponds to a generic query 314 (e.g., a query constructed in the GraphQL query language), which is processed by a generic query language (e.g., GraphQL) controller 306 to obtain a response 318 from the graph database 310. The generic query 314 results in an endpoint 312.

In operation, the generic query language client/UI 304 invokes the endpoint 312 via the GraphQL controller 306. A graph query generator 308 translates the generic query 314 into a graph query 320 constructed in a graph query language, such as GSQL, according to a schema 322 for the graph database 310, as described in further detail below. The graph query 320 is executed on the graph database 310, resulting in a response 318 to the generic query language client/UI 304 via the calling process.

Example Graph Database Schema

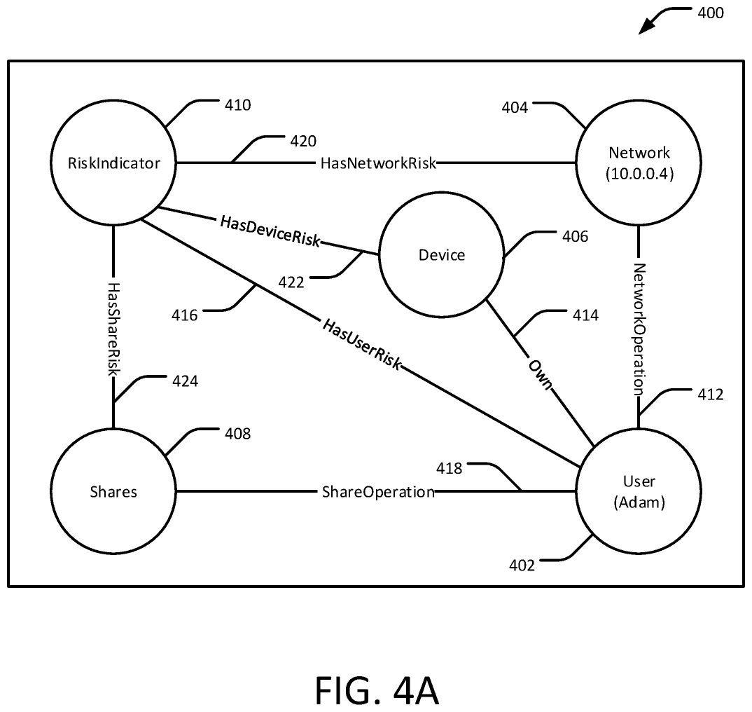

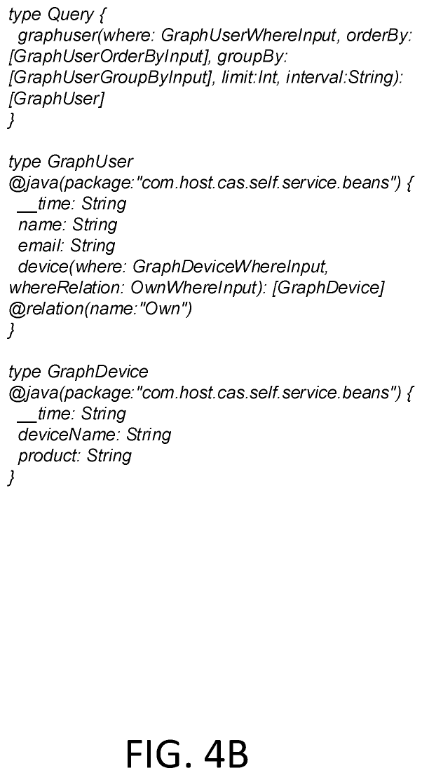

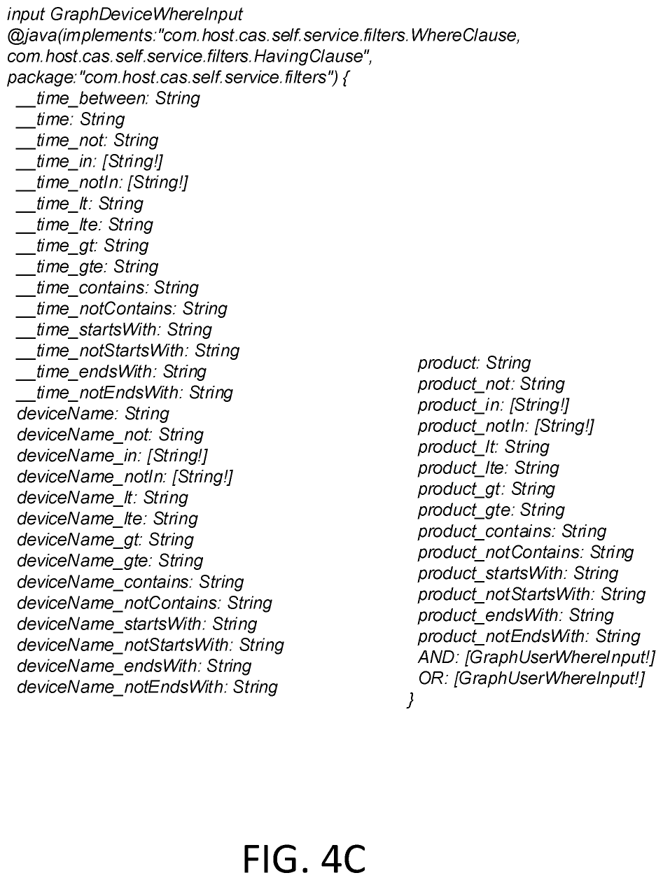

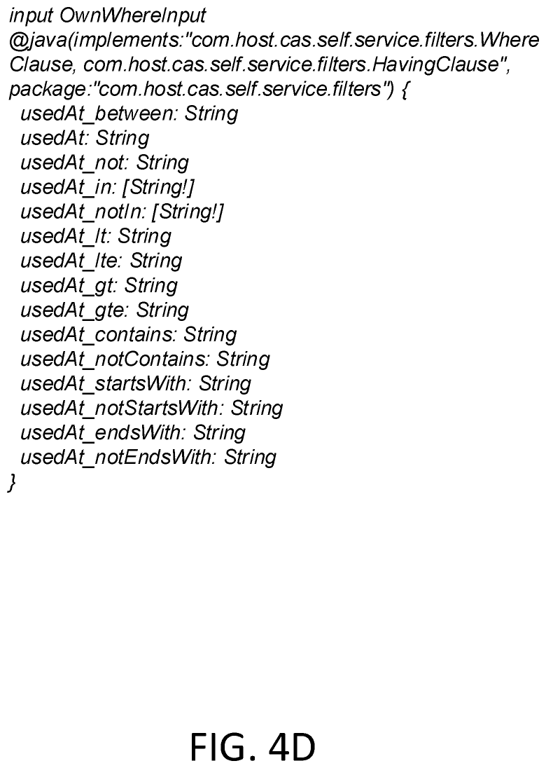

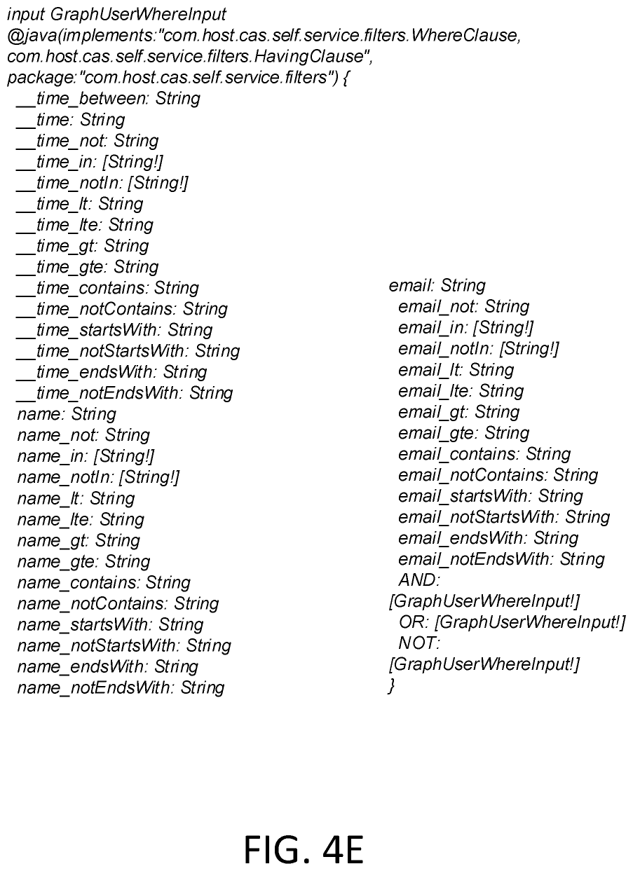

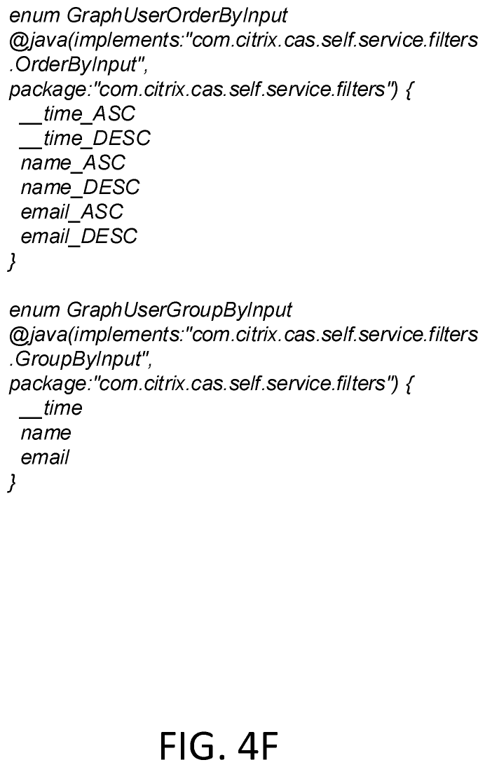

FIG. 4A is a diagram of a graph database schema 400, and FIGS. 4B-F show a GraphQL schema corresponding to a vertex (“graphuser”) in the graph database schema 400 of FIG. 4A, in accordance with examples of the present disclosure. The graph database schema 400 is a representation of the structure of a graph database, such as the graph database 310 of FIG. 3. The graph database schema 400 includes one or more vertices (e.g., 402, 404, 406, 408, 410) representing entities in a computing environment and one or more edges (e.g., 412, 414, 416, 418, 420, 422, 424) connecting the vertices together. The vertices represent entities in a computing environment, such as user computing devices, servers, network communications devices, and other representations of the computing environment such as file shares, accounts, or any other item to be tracked. The edges are the lines that connect vertices and represent the relationship between the connected vertices. Meaningful patterns can be identified by examining the connections represented by the edges. The relationships represented in the schema 400 allow data in the graph database to be linked together directly and, in some cases, retrieved with one operation. It will be understood that the graph database schema 400 described here is merely one possible example and that, in practice, the schema will reflect data that is associated with the computing environment at any given time and is subject to change dynamically as entities enter the environment and as events occur over time. Thus, the graph database schema 400 is not a static representation of the graph database but rather an instantaneous representation of the graph database at a given point in time. For example, the graph database can represent the current state of one or more users and their relationships with other entities (e.g., in FIG. 4A, the user 402 has an ownership relationship 414 with a device 406). In some examples, the graph database schema 400 is updated in real time or in near-real time as entities are added to the environment or as events occur in the environment.

In this example, the graph database schema 400 includes the following entities: User 402, Network 404, Device 406, Shares 408, and RiskIndicator 410. Each of these entities is represented in the graph database schema 400 as a vertex in the graph database. The graph database schema 400 further includes the following relations between entities: NetworkOpertation 412, Own 414, HasUserRisk 416, ShareOperation 418, HasNetworkRisk 420, HasDeviceRisk 422, and HasShareRisk 424. Each of these relations is represented in the graph database schema 400 as an edge between corresponding vertices in the graph database. Each of the vertices and edges in the graph database schema 400 can be associated with data relating to the entities and relations, as will be described by example below.

In an example, consider a user Adam whose account is being attacked. The user Adam is represented by the User 402 vertex in the graph database schema 400, and Adam's computing device (e.g., desktop, laptop, tablet, etc.) is represented by the Device 406 vertex. The relation Own 414 represents the relationship between the User 402 Adam and his Device 406. A hacker attempts to login to Adam's account multiple times from a network with IP 10.0.0.4 but fails to login. All login attempts made by Adam are events, which are are loaded to graph database by creating User vertex “Adam” 402 and Network vertex “10.0.0.4”. The relation NetworkOperation 412 between the two vertices User 402 and Network 404 is created, with the access time set to the current time.

The events are then used to predict or detect any risk using one or more machine learning (ML) or other rule-based models. In this example, the models predict an excessive authorization failures risk, which is associated with the user Adam. The risk is updated in the graph database by creating the RiskIndicator 410 vertex for excessive authorization failures and a relation HasUserRisk 416 between the User 402 and RiskIndicator 410 vertices, with the current time stamp of occurrence and any other related information. Other examples will be apparent in light of this disclosure.

As noted above, FIGS. 4B-F show a GraphQL schema corresponding to a vertex (“graphuser”) in the graph database schema 400 of FIG. 4A. For example, the GraphQL schema can represent one or more attributes of a vertex in the graph database schema 400, such as a name, an email address, and/or a device name for a vertex type GraphUser, and a device name and a product name for a vertex type GraphDevice.

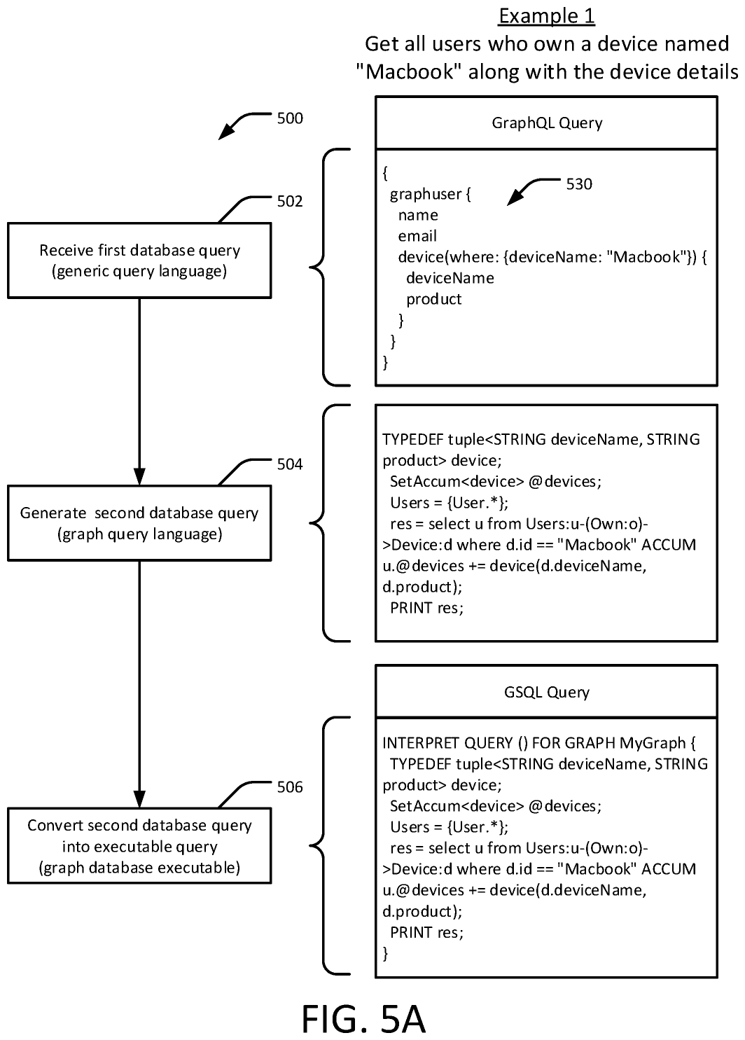

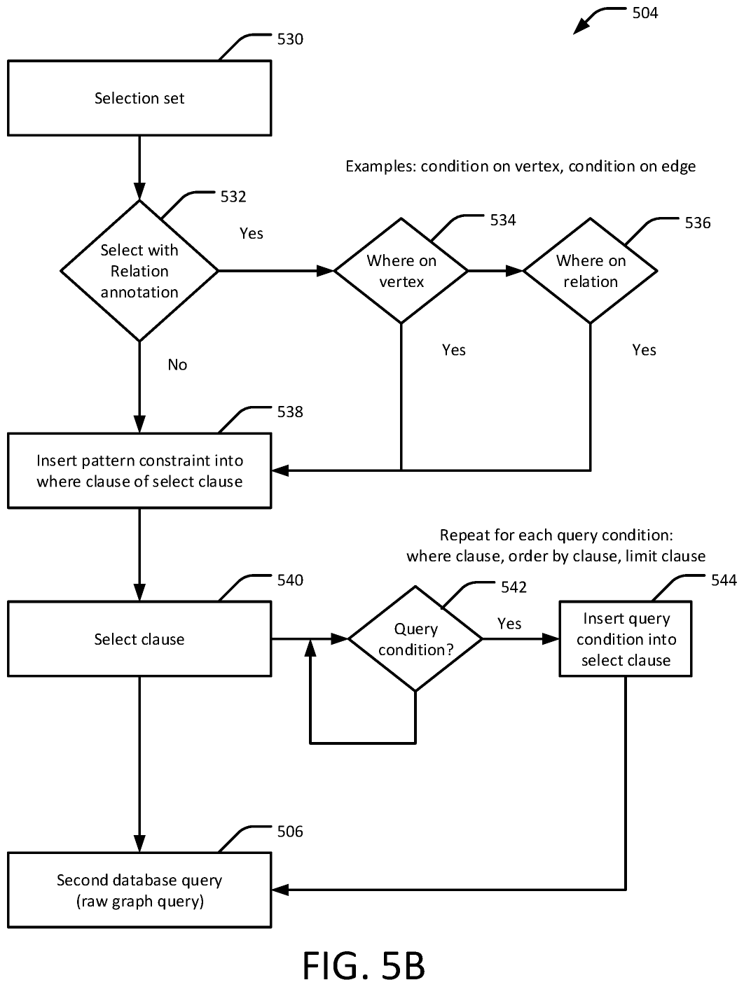

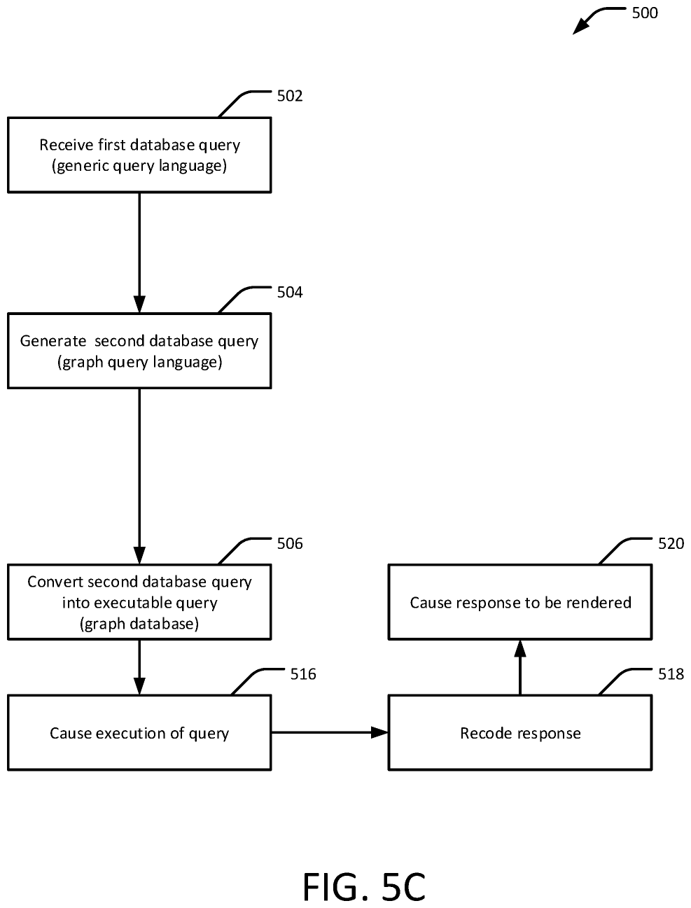

FIGS. 5A-C are flow diagrams of a method 500 for automatically constructing a graph database query, in accordance with an example of the present disclosure. The method 500 can, for example, be implemented at least in part in the graph query generator 308 of FIG. 3. Referring first to FIG. 5A, the method includes receiving 502 a first database query. The first database query includes one or more selection sets 530. Each selection set 530, and any optional query conditions (e.g., where, order by, limit by, etc.), are included in the graph query via at least one graph database schema resolver that corresponds to a vertex in the graph database schema. The resolver defines one or more functions for generating a response to a graph query and includes at least one database field to be queried. For example, the GraphQL query in FIG. 5A exposes a resolver “graphuser.” The at least one database field is represented in a graph database schema as a property of a vertex, such as described with respect to FIGS. 4A-E. For example, the vertex “User” in the graph database corresponds to the “graphuser” resolver exposed by the GraphQL server, which is used to store data, such as “name,” “email,” “device,” and other information. The “device” attribute in the “graphuser” resolver is used, for instance, to fetch device details for a “Device” vertex in the graph database. The relation between the “User” and “Device” vertices in the graph database is represented in the GraphQL schema through the relation annotation “@relation(name:”Own“).” Other examples will be apparent. The first database query is coded in a generic query language, such as GraphQL. In the example of FIG. 5A, the first database query is a GraphQL query for “get all users who own a device named ‘Macbook’ along with the device details.”

The method 500 further includes generating 504, for each of the one or more selection sets, and any optional query conditions (e.g., where, order by, limit by, etc.), a second database query. The second database query can be generated via a calling process. The second database query includes a select clause representing a request to retrieve the property of the vertex corresponding to the selection set (e.g., “graphuser”) from the graph database, such as shown in FIG. 5A, using a “select” cause. The “select” clause includes operands representing the data associated with the vertex (e.g., “graphuser”) corresponding to the selection set in the graph database schema. The second database query is coded in a graph query language, such as GSQL, which includes the query conditions of the first database query (e.g., “get all users who own a device named ‘Macbook’ along with the device details”). Thus, the second database query is a translation of the first database query from the generic query language to the graph query language based on the graph database schema. This translation process (504) is described in further detail with respect to FIG. 5B.

Referring to FIG. 5B, the generating of the second database query 504 includes determining whether the vertex includes a relation annotation. The relation annotation is represented in the graph database by a relation on the vertex and/or by a relation on an edge connected to the vertex. For example, each selection set 530 is checked (at 532) to determine whether it has a relation annotation (relation on vertex 534 and/or relation on edge 536) in the graph database schema. If the current selection set attribute includes a relation annotation (e.g., “@relation(name: “Own”) in the GraphQL schema for the resolver “graphuser”, then a pattern constraint (e.g., the “where” condition on the vertex and/or the edge) is evaluated and inserted 538 into the where clause of the select clause 540, where the pattern constraint corresponds to the relation annotation. The above process is repeated for all the members of the selection set until the select clause 540 is fully constructed.

Next, the generating of the second database query 504 includes determining 542 whether a query condition exists on the selection set 530. Examples of query conditions include but are not limited to a where clause, an order by clause, and/or a limit clause. A “where clause” is, for example, a clause in the second database query that defines a parameter that is to be matched in the database. For example, the query “get all users who own a device named ‘Macbook’” can be constructed as a graph query that includes results from the graph database where the device name is “Macbook,” as will be understood by one of skill in the art. The “where clause” can also exclude results, such as by requesting all results where the result does not include the parameter defined in the query (e.g., result all results where the device name is not “Macbook”). An “order by clause” is, for example, a clause in the second database query that causes the results of the query to be returned in a particular order or sequence. For example, the query “get all users who own a device named ‘Macbook’” can include an “order by name” clause so that the results are returned sorted according to the name. A “limit clause” is, for example, a clause in the second database query that defines a constraint on the number of unique results returned by the query. For example, the query “get all users who own a device named ‘Macbook’” can include a “limit by 5” to limit the number of results returned by the query to five or fewer.

If the second database query includes a query condition, then the query condition is inserted 544 into the select clause of the second database query, which is a raw graph query.

Referring again to FIG. 5A, the method 500 further includes converting 506 the second database query (raw graph query) into a third database query configured to be executed on the graph database. The third database query encapsulates the second database query with additional syntax to convert it to an executable graph query by adding details including the graph query type and graph name, such as shown in FIG. 5A. For example, the third database query is the graph query language query encapsulated by the graph name (e.g., “MyGraph”) in a syntax for executing the translated second database query (raw graph query) on the graph database and returning or otherwise providing the result of the query to the end user.

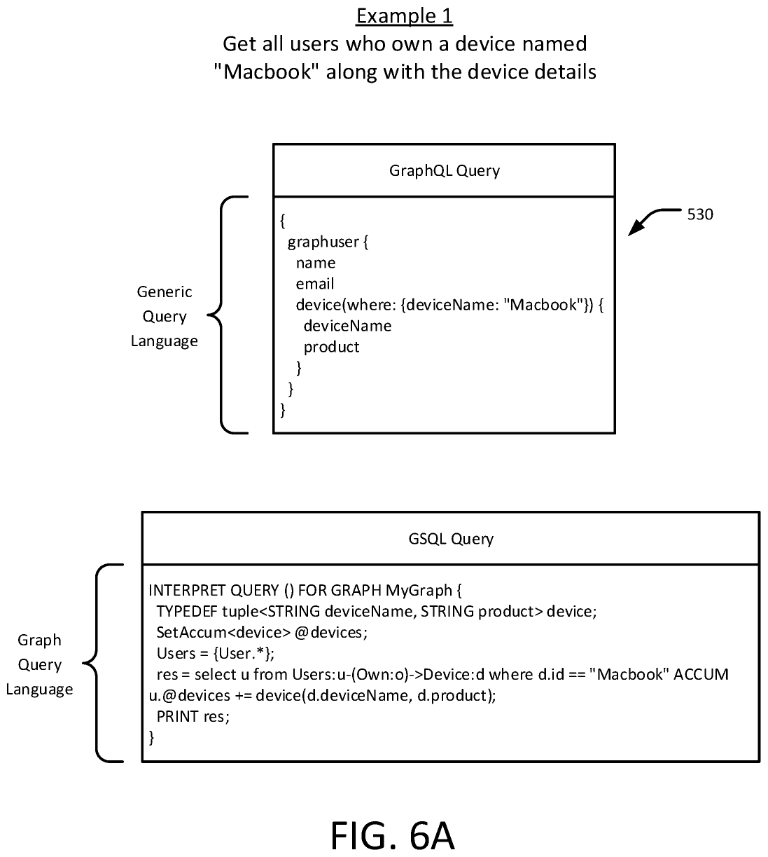

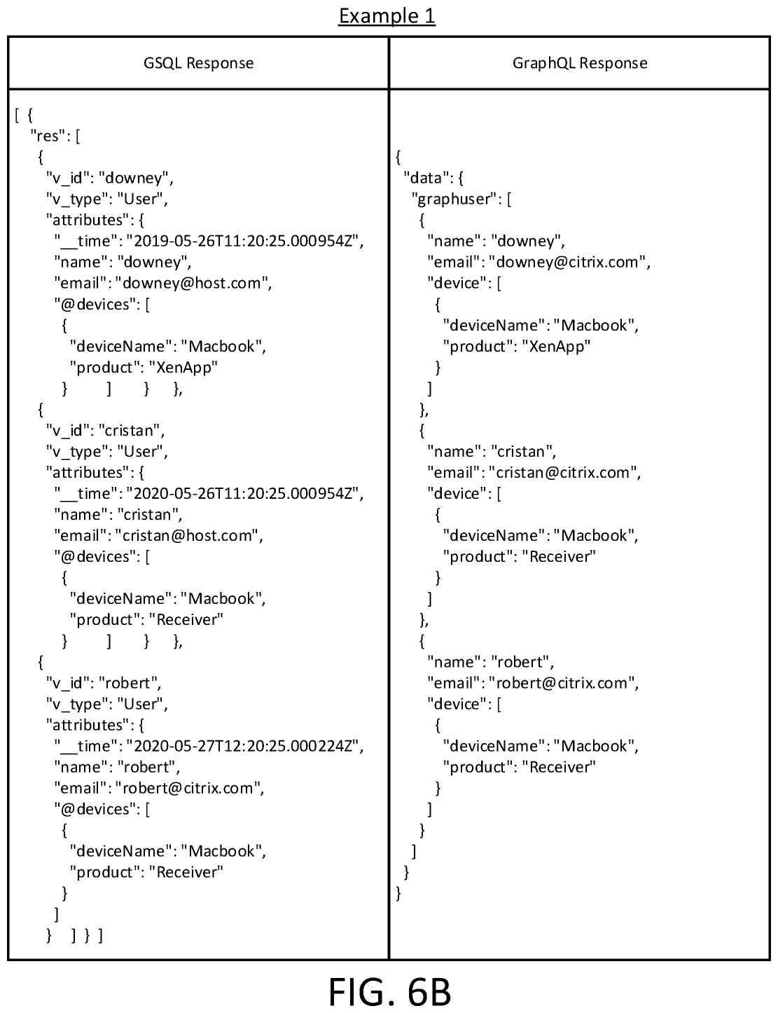

Referring next to FIG. 5C, the method 500 includes causing execution 516 of the third database query on the graph database to produce a response to the third database query and causing the response to be rendered 520 to a user via a user interface of a client computing device. In some examples, the method 500 further includes recoding 518 the response in the generic query language for rendering via the user interface. For example, if the response is coded in the graph query language (e.g., GSQL), the response can be recoded in the generic query language (e.g., GraphQL), such as described with respect to FIGS. 6A-B and 7A-B below.

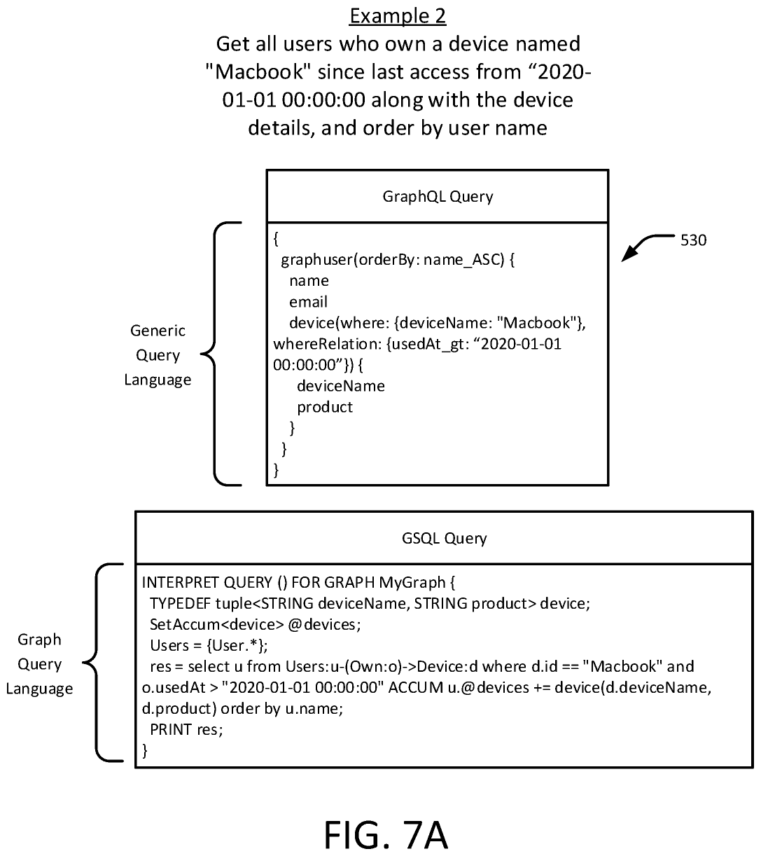

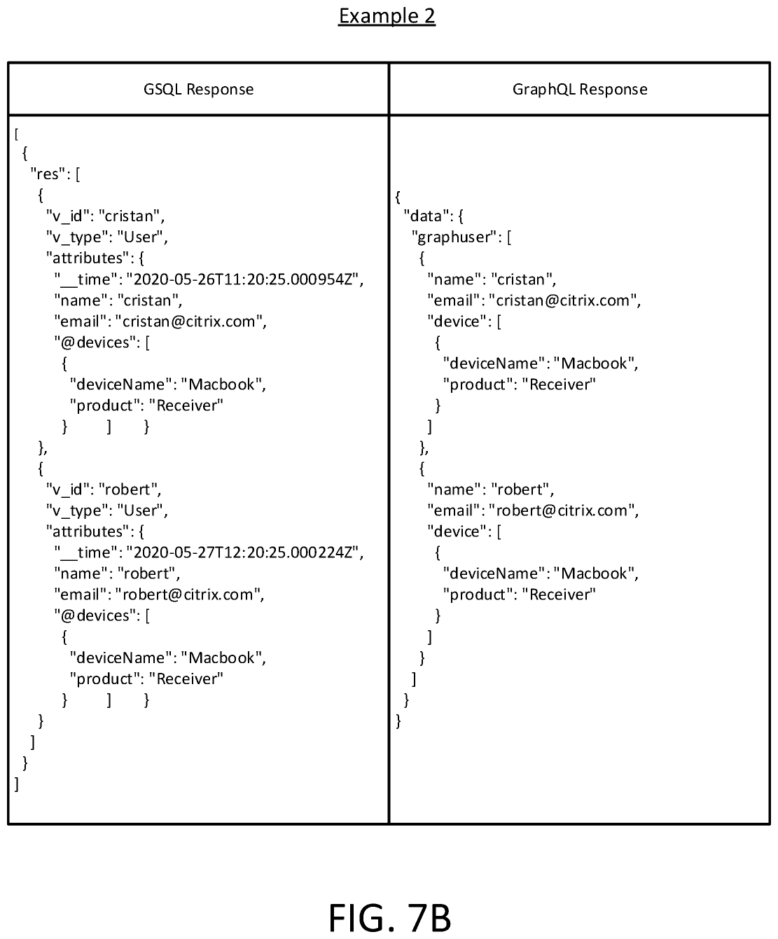

FIGS. 6A-B and 7A-B show examples of a graph database query and response using the techniques disclosed herein. In Example 1 (FIGS. 6A-B), a user desires to query a graph database to “get all users who own a device named ‘Macbook’ along with the device details.” In Example 2 (FIGS. 7A-B), a user desired to query a graph database to “get all users who own a device named ‘Macbook’ since last access from ‘2020 Jan. 1 00:00:00 ordered by the users names.” A first database query can be constructed initially in a generic query language such as GraphQL. The generic query language does not require the developer to have knowledge of the graph query language. Rather, the GraphQL server knows the graph structure for translating the generic (GraphQL) query to the graph database query. Next, the first database query can be translated, via a calling process, into a second database query in a graph query language, such as GSQL, based on a graph database schema corresponding to the graph database, such as the schema shown in FIG. 4A. The second database query reflects the structure of the graph database as represented in the schema.

For example, while the first database query refers generically to a resolver “graphuser” exposed by the GraphQL server, the second database query includes the structural parameters ultimately needed to execute the query on the graph database once the query is translated into the graph query language. For example, the schema of FIG. 4A shows a first vertex “User”, a second vertex “Device”, and an edge “Own” between these two vertexes, which reflects a portion of the structure of the “MyGraph” database. Accordingly, the second database query includes “Users=(User.*)” representing to start query execution from all “User” vertices in the graph, which is then incorporated into the “select” clause as “select u from Users:u.” Further to this example, as the first database query includes to select “device” attribute from the graph database along with condition on device name as “where” clause “where: (deviceName:”Macbook“),” which is incorporated into the graph query as “select u from Users:u-(Own:o)->Device:d where d.id==“Macbook””. The first database query, in this example, further requires deviceName and product information, which is incorporated into the graph query as “ACCUM u.@devices+=device(d.deviceName, d.product)”. Applying the conditions gives rise to the second database query as:
TYPEDEF tuple<STRING deviceName, STRING product> device;
SetAccum<device> @devices;
Users={User.*};
res=select u from Users:u-(Own:o)->Device:d where d.id==“Macbook” ACCUM u.@devices+=device(d.deviceName, d.product);
PRINT res;

After the second database query is executed on the graph database, the database returns a response constructed in the graph query language (e.g., GSQL). The graph query language response is then handed back to the calling process for translation into a generic query language (e.g., GraphQL) prior to rendering the query response to the user.

### Example Computing Platform

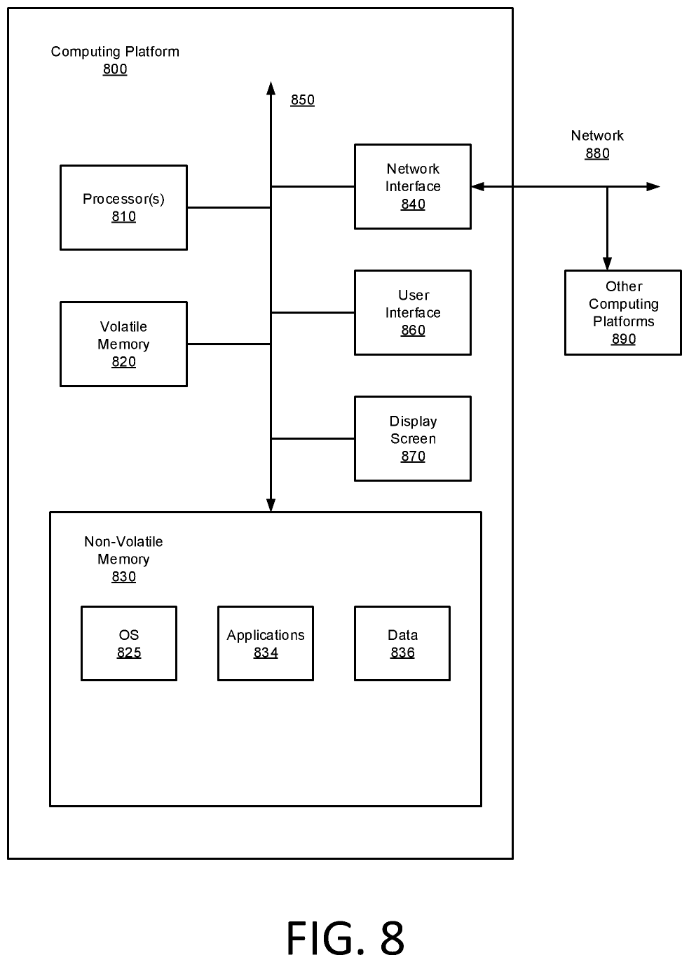

FIG. 8 is a block diagram of a computing platform 800 configured to perform graph-based analytics and query, in accordance with an example of the present disclosure. In some cases, the platform 800 may be a workstation, a laptop computer, a tablet, a mobile device, or any suitable computing or communication device.

The computing platform or device 800 includes one or more processors 810, volatile memory 820 (e.g., random access memory (RAM)), non-volatile memory 830, one or more network or communication interfaces 840, a user interface (UI) 860, a display screen 870, and a communications bus 850. The computing platform 800 may also be referred to as a computer or a computer system.

The non-volatile (non-transitory) memory 830 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 860 can include one or more input/output (I/O) devices (e.g., a mouse, a keyboard, a microphone, one or more speakers, one or more biometric scanners, one or more environmental sensors, and one or more accelerometers, etc.).

The display screen 870 can provide a graphical user interface (GUI) and in some cases, may be a touchscreen or any other suitable display device.

The non-volatile memory 830 stores an operating system (OS) 825, one or more applications 834, and data 836 such that, for example, computer instructions of the operating system 825 and the applications 834, are executed by processor(s) 810 out of the volatile memory 820. In some examples, the volatile memory 820 can include one or more types of RAM and/or a cache memory that can offer a faster response time than a main memory. Data can be entered through the user interface 860. Various elements of the computer platform 800 can communicate via the communications bus 850.

The illustrated computing platform 800 is shown merely as an example computing device and can be implemented by any computing or processing environment with any type of machine or set of machines that can have suitable hardware and/or software capable of operating as described herein.

The processor(s) 810 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 810 can be analog, digital, or mixed. In some examples, the processor 810 can be one or more physical processors, which may be remotely located or local. A processor including multiple processor cores and/or multiple processors can provide functionality for parallel, simultaneous execution of instructions or for parallel, simultaneous execution of one instruction on more than one piece of data.

The network interfaces 840 can include one or more interfaces to enable the computing platform 800 to access a computer network 880 such as a Local Area Network (LAN), a Wide Area Network (WAN), a Personal Area Network (PAN), or the Internet through a variety of wired and/or wireless connections, including cellular connections. In some examples, the network 880 may allow for communication with other computing platforms 890, to enable distributed computing. In some examples, the network 880 may allow for communication with the one or more of the end user client device(s) 102, 202, 302, the REST controller server 106, 206, the REST client/UI 104, 204, the data access layer 108, 208, the SQL database 110, the GraphQL client/UI 304, the GraphQL controller 306, the graph query generator 308, and/or the graph database 210, 310 of FIGS. 1-3.

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A method comprising:
receiving a first database query including one or more selection sets each defining at least one database field to be queried from a graph database, wherein the first database query is coded in a generic query language, wherein the at least one database field is represented in the graph database as a property of a vertex;
generating, for each of the one or more selection sets, a second database query including a select clause representing a request to retrieve the property of the vertex from the graph database, wherein the second database query is coded in a graph query language; and
encapsulating the second database query into a third database query configured to be executed on the graph database, the third database query including the second database query, a graph query type, and a graph name associated with the graph database.

2. The method of claim 1, wherein the first database query includes a query condition, and wherein the method further comprises inserting the query condition into the select clause.

3. The method of claim 2, wherein the query condition includes one or more of: a where clause, an order by clause, and/or a limit clause.

4. The method of claim 1, further comprising:
determining whether the vertex includes a relation annotation, wherein the relation annotation is represented in the graph database by a relation on the vertex and/or by a relation on an edge connected to the vertex; and
inserting, in response to determining that the vertex includes the relation annotation, a pattern constraint to the select clause, the pattern constraint corresponding into the relation annotation.

5. The method of claim 1, further comprising:
causing the third database query to be executed on the graph database to produce a response to the third database query; and
causing the response to be rendered to a user via a user interface of a client computing device.

6. The method of claim 5, wherein the response is coded in the graph query language, and wherein the method further comprises recoding the response in the generic query language for rendering via the user interface.

7. The method of claim 5, wherein the first database query is a GraphQL query, and wherein the response is a GraphQL response.

8. The method of claim 1, wherein the generic query language is different from the graph query language.

9. A computer program product including one or more non-transitory machine-readable mediums having instructions encoded thereon that when executed by at least one processor cause a process to be carried out, the process comprising:
receiving a first database query including one or more selection sets each defining at least one database field to be queried from a graph database, wherein the first database query is coded in a generic query language, wherein the at least one database field is represented in the graph database as a property of a vertex;
generating, for each of the one or more selection sets, a second database query including a select clause representing a request to retrieve the property of the vertex from the graph database, wherein the second database query is coded in a graph query language; and
encapsulating the second database query into a third database query configured to be executed on the graph database, the third database query including the second database query, a graph query type, and a graph name associated with the graph database.

10. The computer program product of claim 9, wherein the first database query includes a query condition, and wherein the process further comprises inserting the query condition into the select clause.

11. The computer program product of claim 10, wherein the query condition includes one or more of: a where clause, an order by clause, and/or a limit clause.

12. The computer program product of claim 9, wherein the process further comprises:
determining whether the vertex includes a relation annotation, wherein the relation annotation is represented in the graph database by a relation on the vertex and/or by a relation on an edge connected to the vertex; and
inserting, in response to determining that the vertex includes the relation annotation, a pattern constraint to the select clause, the pattern constraint corresponding into the relation annotation.

13. The computer program product of claim 9, wherein the process further comprises:
causing the third database query to be executed on the graph database to produce a response to the third database query; and
causing the response to be rendered to a user via a user interface of a client computing device.

14. The computer program product of claim 13, wherein the response is coded in the graph query language, and wherein the process further comprises recoding the response in the generic query language for rendering via the user interface.

15. The computer program product of claim 13, wherein the first database query is a GraphQL query, and wherein the response is a GraphQL response.

16. A system comprising:
a storage; and
at least one processor operatively coupled to the storage, the at least one processor configured to execute instructions stored in the storage that when executed cause the at least one processor to carry out a process including
receiving a first database query including one or more selection sets each defining at least one database field to be queried from a graph database, wherein the first database query is coded in a generic query language;
generating, for each of the one or more selection sets, a second database query, wherein the second database query is coded in a graph query language; and
encapsulating the second database query into a third database query configured to be executed on the graph database.

17. The system of claim 16, wherein the first database query includes a query condition, and wherein the process further comprises inserting the query condition into the second database query, and wherein the query condition includes one or more of: a where clause, an order by clause, and/or a limit clause.

18. The system of claim 16, wherein the process further comprises:
determining whether the graph database includes a relation annotation; and
inserting, in response to determining that the graph database includes the relation annotation, a pattern constraint to the second database query, the pattern constraint corresponding into the relation annotation.

19. The system of claim 16, wherein the process further comprises:
causing the third database query to be executed on the graph database to produce a response to the third database query; and
causing the response to be rendered to a user via a user interface of a client computing device.

20. The system of claim 19, wherein the response is coded in the graph query language, and wherein the process further comprises recoding the response in the generic query language for rendering via the user interface.
